(19) United States
(12) Patent Application Publication
(10) Pub. No.: US 2013/0023289 A1
(43) Pub. Date: Jan. 24, 2013

(54) Location Based Service and System

(71) Applicant: Richard A. Gorgens, Plantation, FL (US)

(72) Inventor: Richard A. Gorgens, Plantation, FL (US)

(21) Appl. No.: 13/550,850

(22) Filed: Jul. 17, 2012

Related U.S. Application Data
(60) Provisional application No. 61/508,735, filed on Jul. 18, 2011.

(51) Int. Cl. H04W 64/00

(52) U.S. Cl. 455/456.3

(57) ABSTRACT

A location based service and system wherein a database includes customer records each mapped to customer location information. A user device launches a request to the server. The request includes user device location data, from the user device location data, a geopositional frame about the user location is calculated and used to search customer location information in the database and to retrieve customer records within the geopositional frame corresponding to the launched request.

### RELATED APPLICATIONS

This application claims benefit of and priority to U.S. Provisional Application Ser. No. 61/508,735, filed Jul. 18, 2011, under 35 U.S.C. §§119, 120, 363. 365, and 37 C.F.R. §1.55 and §1.78 and is incorporated herein by this reference.

### FIELD OF THE INVENTION

The invention relates to location based deals and alerts and similar location based services.

### BACKGROUND OF THE INVENTION

Location based services allow users to receive deals such as coupons and alerts on their smart devices (such as a cell phone) based on the location of the user. See, for example, U.S. Pat. No. 7,848, 765 incorporated herein by this reference.

In general, once the location of a user is determined, information from one or more databases is provided to the user device. In one example, the user may request the location of coffee shops with a mile of the user. The server determines the location of the user and a database is searched to retrieve all coffee shops close to the user's position. The retrieved information is then returned to the user device and displayed thereon.

Searching the database(s), which may contain numerous records, is time consuming resulting in a delay of providing the requested information to the user especially if all the database records have to be analyzed.

### SUMMARY OF THE INVENTION

Featured is a location based method and system in which database records are searched more efficiently using the construct of a geopositional frame resulting in a faster process.

Featured is a location based service comprising building a database including customer records each mapped to customer location information accessed by a server and allowing a user device to launch a request to the server. The request includes user device location data. From the user device location data, a geopositional frame about the user location is calculated and used to search customer location information in the database and retrieving customer records within the geopositional frame corresponding to the launched request. Retrieved customer records are returned to the user device.

Preferably, the customer location information includes a longitude hash table and a latitude hash table. Calculating a geopositional frame may include specifying the latitude and longitude of opposing corners of a polygon (e.g., a trapezoid) surrounding the user device location.

Searching customer location information in the database may include specifying longitude hash table and latitude hash table ranges based on the latitude and longitude of the opposing corners of said polygon. In one example, the user device is configured to calculate the geopositional frame.

A location based service system includes a database with customer records each mapped to customer location information accessed by a server, a user device configured to launch a request including user device location data, and a server configured to receive the request and user device location data, search customer location information in the database using a geopositional frame about the user location, retrieve customer records within the geopositional frame corresponding to the launched request, and return retrieved customer records to the user device.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a block diagram showing several of the components associated with an example of a system in accordance with the invention;

FIG. 2 is a schematic view showing the user device of FIG. 1 including a display showing the results forwarded to the user device based on a query launched by the user device;

FIG. 3 is a highly schematic representation of the database of FIG. 1 showing the data stored there and the geopositional frame used in accordance with the invention to more quickly retrieve data from the database;

FIG. 4 is a flow chart depicting the primary steps associated with a method and programming for the deal aspect of an example of the invention; and

FIG. 5 is a flowchart depicting the primary steps associated with a method and programming for the alert aspect of an example of the invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

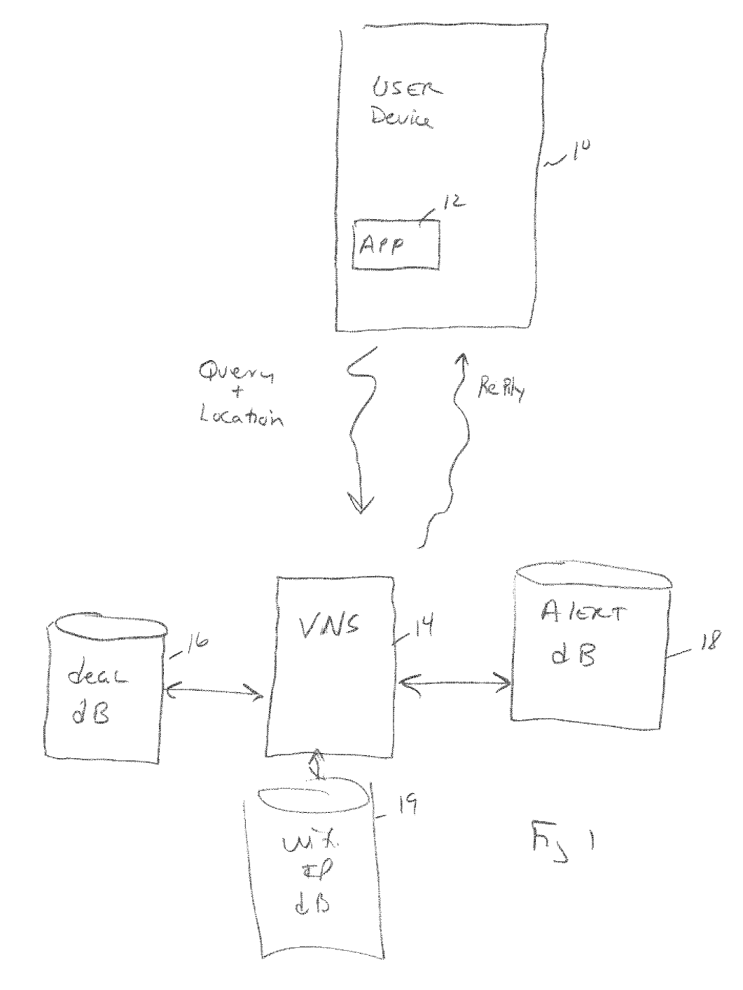

In FIG. 1, user device 10 such as smart phones includes an application 12 which enables the user device to make queries based on location. An example of a query is to request the location of all coffee shops within a defined radius in this example we will use a one mile radius of the user's position. The users position may be based on GPS coordinates (if the user device 10 includes GPS technology), cell tower absolute location or triangulation techniques, and/or the IP address of a Wi-Fi router accessed by the user device coupled with data concerning the geographic location of the IP address stored in Wi-Fi database 14. Other methods for obtaining the user's location are possible, Also. see co-pending U.S. patent application Ser. Nos. 13/385,663, and 61/689,383 incorporated herein by this reference.

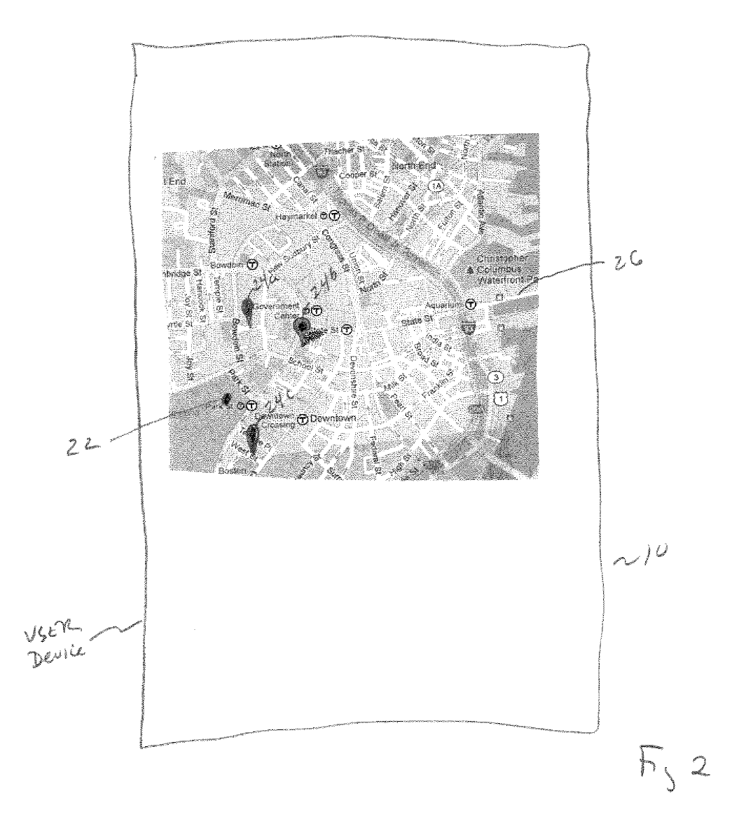

Virtual network server (VNS) 14 is a server or a set of servers which receives the users' query and location information. The software application queries a central server which referred to as the VNS Virtual Network Server. Note that this central server may be a single server, redundant servers, or a multitude of servers each handling a specific set of categories or geographic regions. VNS 14 searches deal database 16 which includes customer records each mapped to customer location information. In the example above, numerous customers may be classified in the deal database 16 as “coffee shops” but server 16 only retrieves those customer records for coffee shops which are within one mile of the user device. In FIG. 2, the user is located at 22 and three coffee shops 24a, 24b, and 24c are displayed on map 26 for the convenience of the user.

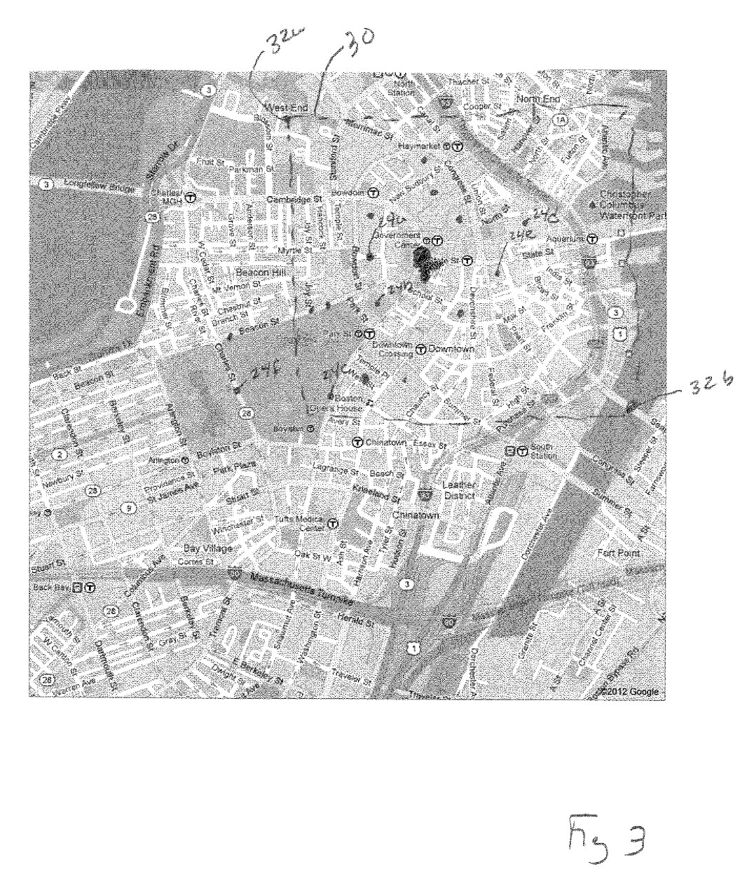

Database 16 may include numerous customer records each mapped to customer location information as schematically depicted in FIG. 3 where customer data resides at locations 24a, 24b, 24c, 24d, and the like. But, customer data record 24d may be for a supermarket while record 24e may be for a department store. Data or record 24f may be for a coffee shop but this coffee shop is for further away than one mile from the current location of the user. In a large database with may records, there would be a large number of coffee shop customer records which are not within a mile of the user's position.

In one embodiment, application 12 and/or server 14, FIG. 1 calculates a geopositional frame graphically represented at 30 in FIG. 3 specifying the latitude and longitude of opposing corners of a polygon (typically a trapezoid) surrounding the user's position. For simplicity in this example, frame 30 is a square one mile across. The latitude and longitude of the upper left hand corner 32a may be used along with the latitude and longitude of the lower right hand corner 32b.

As an illustrative description, this geopositional frame is overlaid on the data of database 16, FIG. 1 as shown in FIG. 3 to quickly search for customer location records of the database within the frame and, for those, retrieving the appropriate customer records which correspond to the user's request. In this way, the database is constructed and the server searches in a way that results in faster responses.

Alert database 18, FIG. 1 includes deal, weather, traffic, police, and other alerts to be forwarded to use device 10 by VNS server 14 when the user device enters an alert area. In FIG. 3, geopositional frame 30 could now be considered an alert stored in database 18, FIG. 1 and when server 14 deter mines that the user device 10 has latitude and longitude coordinates within frame 30, FIG. 3 VNS 14, FIG. 1 delivers to the user the information concerning the alert. Again, server 14 does not have to search all the database alert records whenever the user device position changes. Instead, only the alerts corresponding to the geopositional frame bounding the user position are searched.

Databases 16 and 18 preferably makes use of hash tables, for example, longitude and latitude hash tables concerning customer and alert records as explained below.

For easier comprehension, use the x axis for representing a location longitude and the y axis for its latitude. Since all current mobile devices can determine its location via GPS (or AGPS) and the location coordinates (Longitude and Latitude) are in decimal degrees, it will help if we use a unit system facilitating the database record setup, server fast lookup and the device submitting its location when requesting data for its current location. This unit system constitutes the “hashed” value of the decimal degree coordinate.

The precision for each incremental integer unit can be down to 9.33 mm. The device and the data server 14 will use this “hashed” unit system to converse with the device preparing the submitted device coordinates and the server doing fast binary search on sorted “hashed” coordinates records.

Below are some C/C++ definitions of how to convert back and forth between decimal degrees and VNS hashed unit system.

//-- GPS CONVERSIONS DEGREES TO/FROM INTEGER UNITS
(maximum integer unit = Earth_Circumference/2\hat{ }32 = 9.33 mm)
#define GFACX 11930464 // 2\hat{ }31/180 - longitude factor
(signed values)
#define GFACY 23860929 // 2\hat{ }31/90 - latitude factor
(signed values)
// Decimal degrees to VNS integer units
#define GPX2I(x) ((int)floor((double)(x)*(double)GFACX+0.5)) //
rounding: in gcc/xcode you can use round( ) without +0.5
#define GPY2I(y) ((int)floor((double)(y)*(double)GFACY+0.5))
// VNS Integer units to decimal degrees
#define I2GPX(x) ((double)(x)/(double)GFACX)
#define I2GPY(y) ((double)(y)/(double)GFACY)

Next is the description of the VNS record with can hold in its opaque content either a deal type data or an alert type data.

//-- VNSDREC.f - VNS Record Flags

| | |
|---|---|
| GPF_MASTER = 0x8, | // Master record (other records may |
| | reuse its sections) |
| GPF_SLAVE = 0x10, | // Slave record (depends on master record), |

only one ofr _MASTER or _SLAVE set, not both

| | |
|---|---|
| GPF_ALERT = 0x20, | // Alert system record |
| GPF_VIGN = 0x40, | // VNS should ignore if this bit set |
| GPF_OFF = 0x80, | // record disabled (VNS ignores this record) |

```
//-- VNS DATABASE RECORD (in GPS.DAT or GPA.DAT on VNS)
typedef struct _vnsdrec {
  int x1,y1; // 1st coordinate (integer units:
longitude(−180,180)*GFACX, latitude(− 90,+90)*GFACY,
rounded to int)
  int x2,y2; // 2nd coordinate: x2>=x1, y2>=y1; if x2==x1 &&
y2==y1 -> specifies single point
  qword cm; // content mask (64 bit flags to filter sites)
```

| | |
|---|---|
| byte f; | // record control flags (GPF_*) |
| byte xf; | // future extended flags (GPXF_*) |

| | |
|---|---|
| short plen; | // payload length (of .buf[ ]) |
| short jlen; | // length of js record (js record starts at .buf+.plen) |
| byte bofs; | // offset of .buf[ ] field from start of GPSDREC, ignore |

if =0 (for use by older clients in case we add more fields before .buf[ ];
ignored by VNS since VNS is compiled with any latest VNSDREC &
correct .buf[ ] field)

| | |
|---|---|
| byte zpad; | // reserved (zero padded) |
| dword expir; | // expiration time (GMT from 32 bit C time( ) function) |
| byte buf[ ]; | // buf[plen] = payload: site specific data (opaque to VNS) |
| } VNSDREC; | |

The VNS database lookup works on the header of the two attached payloads. The 1st is the Store info such as address, phone number, and other NON-deal related info. The 2nd is the Deal payload such as 15% off Ladies Dresses. The Master/Slave record flags with the associated record numbers allows the VNS to substitute a deal payload from the Master record to the Slave record payload very quickly. By doing this chain stores need only update the master record deal payload in the database and any lookup on perhaps 30,000 slave stores will be sent with the response data.

When the VNS server is setting up the deal and alert databases, the deal records are sorted in increasing x location order and the alert records are sorted in 2 tables of lower left (x1) and upper right (x2) in increasing x location order.

Use mX and mY as the device's location, n1 as number of alerts, vL as the alert left edge table, vR as the alert right edge one, n2 as number of deals, v as the deal table. For deals, we also need rr for requesting area rectangle.

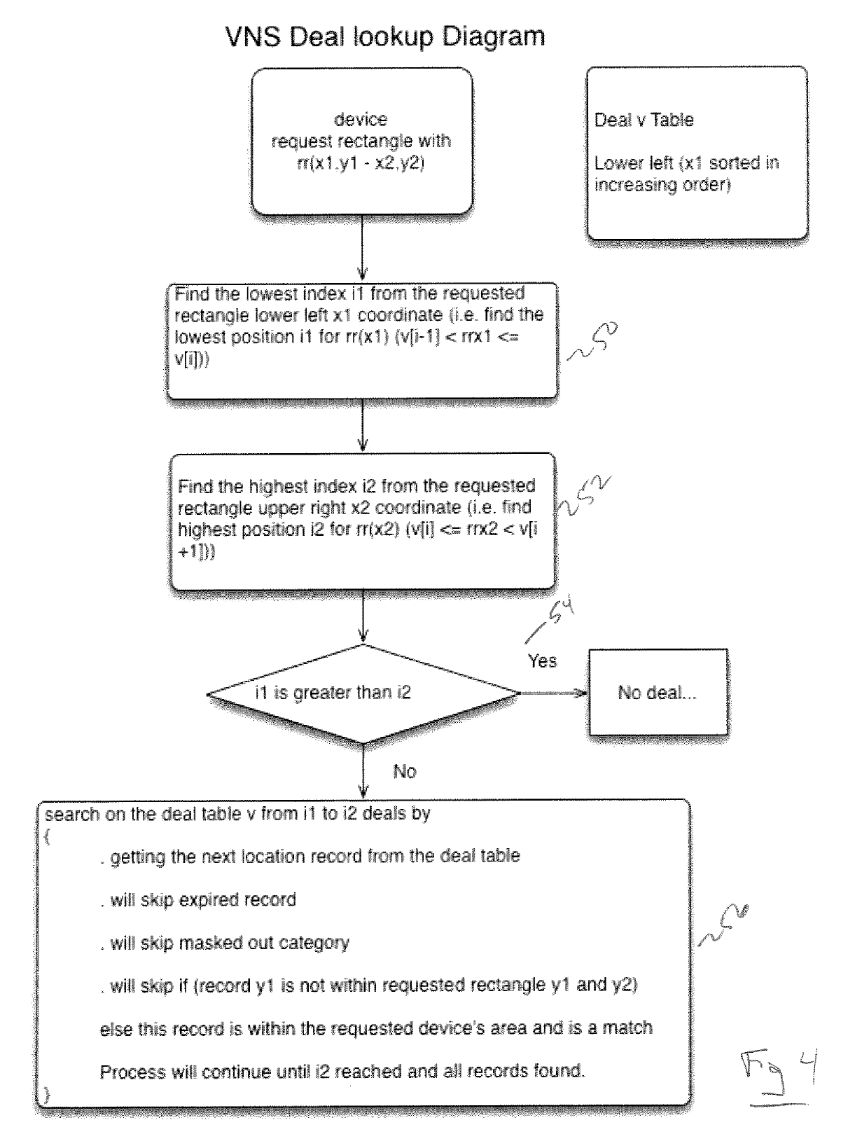

To search the deal records for all deal which are inclusive of the device's requested rectangle area: First, the deal search algorithm will find the lowest index i1 from the requested rectangle lower left x1 coordinate (i.e. find the lowest position i1 for rr(x1) (v[i−1]<rrx1<=v[i])), step 50, FIG. 4. Next, it will find the highest index i2 from the requested rectangle upper right x2 coordinate (i.e. find highest position i2 for rr(x2) (v[i]<=rrx2<v[i+1])), Step 52. If i1 is greater than i2, we have no deals, step 54. It will search on the deal table v from i1 to i2 deals by:
getting the next location record from the deal table
will skip expired record
will skip masked out category
will skip if (record y1 is not within requested rectangle y1 and y2) else this record is within the requested device's area and is a match

This process will continue until i2 reached and all records found, step 56.

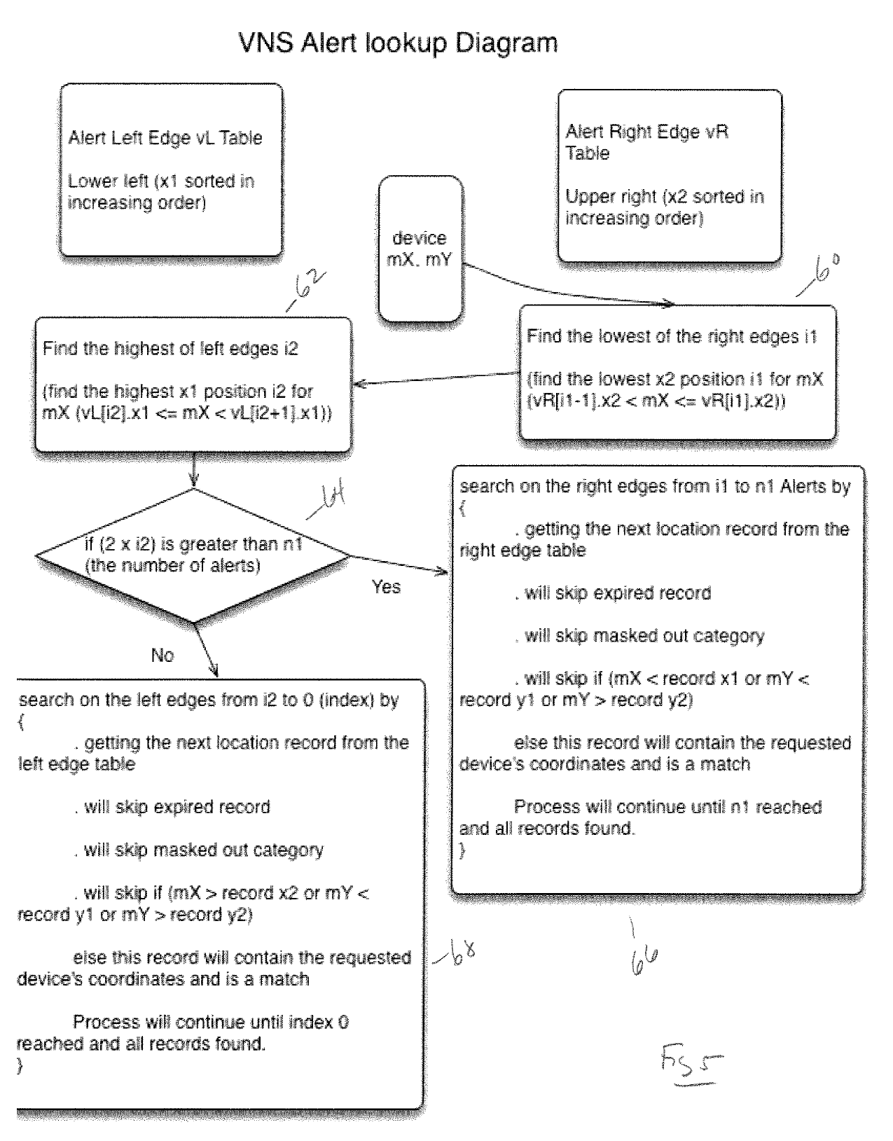

To search the alert records for all alerts which the device coordinates can belong to any alert's area. First, the alert search algorithm will find the lowest of the right edges i1 (i.e. find the lowest x2 position i1 for mX (vR[i1−1]·x2<mX<=vR[i1]·x2)), step 60, FIG. 5. Next, it will find the highest of left edges i2 (i.e. find highest x1 position i2 for mX (vL[i2]·x1<=mX<vL[i2+1]·x1)), step 62. If (233 i2) is greater than n1 (the number of alerts), step 64 it will search on the right edges from i1 to n1 Alerts by, as shown at 66:
getting the next location record from the right edge table
will skip expired record
will skip masked out category
will skip if (mX<record x1 or mY<record y1 or mY>record y2) else this record will contain the requested device's coordinates and is a match

Process will continue until n1 reached and all records found.

else
it will search on the left edges from i2 to 0 (index) by. as shown at 68:
getting the next location record from the left edge table
will skip expired record
will skip masked out category
will skip if (mX>record x2 or mY<record y1 or mY>record y2)

else this record will contain the requested device's coordinates and is a match

Process will continue until index 0 reached and all records found.

In some examples, calculated is the size of the geopositional frame as defined by the top-left longitudinal and latitudinal and bottom-right longitudinal and latitudinal coordinates of the area to be searched by the VNS based on the geopositional information regarding the geographic location of the user. For alerts, instead of storing customer as a single geopositional point, the database now additionally stores a geopositional frame concerning an alert as defined by the top-left longitudinal and latitudinal and bottom-right longitudinal and latitudinal coordinates of the area containing the alert or warning. The user's coordinates are used to determine whether or not the user is within the geopositional frame and if so it issues an alert notification or warning to a user. For either deals or alerts the user can initiate the process by opening an application or browser applet. Different kinds of alerts include a missing person alert, a missing pet alert, weather alerts, and the like. Another alert is a customer which desires to notify users who come within a set radius of the customers' facility.

Although specific features of the invention are shown in some drawings and not in others, this is for convenience only as each feature may be combined with any or all of the other features in accordance with the invention. The words “including”. “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A location based service comprising:
building a database including customer records each mapped to customer location information accessed by a server;
allowing a user device to launch a request to the server, the request including user device location data;
from the user device location data, calculating a geopositional frame about the user location;
using the geopositional frame to search customer location information in the database and retrieving customer records within the geopositional frame corresponding to the launched request; and
returning the retrieved customer records to the user device.

2. The method of claim 1 in which the customer location information includes a longitude hash table and a latitude hash table.

3. The method of claim 2 in which calculating a geopositional frame includes specifying the latitude and longitude of opposing corners of a polygon surrounding the user device location.

4. The method of claim 3 in which the polygon is a trapezoid.

5. The method of claim 3 in which searching customer location information in the database includes specifying longitude hash table and latitude hash table ranges based on the latitude and longitude of the opposing corners of said polygon.

6. The method of claim 1 in which the user device is configured to calculate the geopositional frame.

7. A location based service system comprising:
a database including customer records each mapped to customer location information accessed by a server;
a user device configured to launch a request including user device location data; and
a server configured to:
receive the request and user device location data,
search customer location information in the database using a geopositional frame about the user location,
retrieve customer records within the geopositional frame corresponding to the launched request, and
return retrieved customer records to the user device.

8. The system of claim 7 in which the customer location information includes a longitude hash table and a latitude hash table.

9. The system of claim 7 in which the geopositional frame specifies the latitude and longitude of opposing corners of a polygon surrounding the user device location.

10. The system of claim 9 in which the polygon is a trapezoid.

11. The system of claim 9 in which searching customer location information in the database includes specifying longitude hash table and latitude hash table ranges based on the latitude and longitude of opposing corners of said polygon.

12. The system of claim 7 in which the user device is configured to calculate the geopositional frame.
